(19) United States
(12) Patent Application Publication
(10) Pub. No.: US 2008/0063595 A1
(43) Pub. Date: Mar. 13, 2008

(54) Multifunctional Additive

(75) Inventors: Rudiger Nass, Riegeisberg (DE); Detlef Burgard, Volklingen (DE)

Correspondence Address: HARNESS, DICKEY & PIERCE, P.L.C., P.O. BOX 828, BLOOMFIELD HILLS, MI, 48303, US

(73) Assignee: AIR PRODUCTS AND CHEMICALS, INC., Allentown, PA (US)

(21) Appl. No.: 11/572,843

(22) PCT Filed: Aug. 1, 2005
(86) PCT No.: PCT/DE05/01375

§ 371 Date: Aug. 8, 2007

(30) Foreign Application Priority Data
Jul. 30, 2004 (DE) 10 2004 037 210.1

(51) Int. Cl. C01G 23/00; C01B 13/00

(52) U.S. Cl. 423/598; 423/592.1; 423/593.1

(57) ABSTRACT

The invention relates to a transparent conductive oxide material. According to the invention, said oxide material is provided with at least one metal that is capable of modifying the spectral characteristics.

### FIELD

The present invention relates to what is claimed in the independent claims. Thus, the invention generally relates to transparent conductive oxide materials and the use thereof.

### BACKGROUND

Transparent conductive oxide materials are generally known. Thus, in addition to precious metals, oxide materials such as ATO (SnO₂:Sb), AZO (ZnO:Al) or ITO (In₂O₃:Sn) which as thin films reduce the transparency of glass panes for IR radiation are used. To this end, the oxide materials are generally applied to glass panes by vapor deposition methods. The dense layers formed result in reduced transmission of infrared radiation while being transparent in the visible region, so that the glass panes can be employed as windows for buildings or in the automobile field.

Although the usual vapor deposition method is a standard method for flat glass segments, it is very expensive due to the high consumption of material and the relatively expensive equipment and is economically viable only for high throughput rates. In addition, vapor deposition is not very suitable for plastics or similar materials and for geometries with clearly curved shapes.

Now, just in the automobile field, it is desirable to be able to use plastic materials instead of glass. However, since plastic materials are also IR-transparent as a rule, it is advantageous for the climate within the car to apply IR-shielding layers to such plastic materials and thus to counteract the heating of the interior. As set forth above, however, this is possible only to some extent by means of vapor deposition.

It has been tried before to prepare IR-absorbing plastic materials rather than coating plastic materials. Thus, on the one hand, oxide materials which render the plastic material less transparent to infrared radiation are admixed with the plastics; on the other hand, oxide materials which confer some resistance to ultraviolet radiation to the plastic material are added. In addition, even coloring materials are added in some instances.

EP 0 893 409 B1 already disclosed zinc oxide based particles which comprise a metal oxide coprecipitate. The latter contains an additional metal element from the groups IIIb and IVb as well as zinc. The average size of the particles is from 0.001 to 0.1 μm.

US 2003/0224162 A1 discloses a process for the preparation of a film which is both transparent and conductive as a coating by means of a solution of metal nanoparticles in which the metal in the nanoparticles is oxidized to the metal oxide during a coating step.

DE 199 40 458 A1 describes a process for the thermal alteration of semiconductive coating materials to which, while being in a solid form, is applied an alternating electromagnetic field for bringing about said alteration.

A soil-repellent coating agent with spectral-selective properties is described in DE 100 10 538 A1.

However, the large number of different, typically inorganic, materials which are to be incorporated in the plastic material is usually found to be problematic and reduces the processability of the plastic material.

### DRAWINGS

The drawings described herein are for illustration purposes only and are not intended to limit the scope of the present disclosure in any way.

FIG. 1 is a graph depicting the spectral property or transmission of the ITO layers plotted against the wavelength;

FIG. 2 is a graph showing the transmission curve and thus the spectral behavior of the prepared layers as a function of wavelength;

FIG. 3 is a graph showing the transmission curve for these layers; and

FIG. 4 is a graph showing the prepared layers have a lower transmittance for UV radiation than comparable ITO layers.

### DETAILED DESCRIPTION

It is the object of the present invention to provide something novel for commercial use.

The solution to this problem is claimed in an independent form. Preferred embodiments are found in the dependent claims.

Thus, in a first aspect, the present invention provides an intrinsically transparent conductive oxide material, said oxide material being provided with at least one metal suitable for altering the spectral properties.

As used herein, “metals” also refers to metal ions, a combination of several metals or their ions. By introducing this metal, the spectral properties, i.e., the capability of the oxide material of transmitting, absorbing and reflecting electromagnetic radiation of different wavelengths, is changed. Surprisingly, although the oxide material itself typically is to be employed in low amounts, it is possible to bring about an appreciable change of the spectral properties by providing such low amounts with even lower, trace amounts of metal.

Even after said introducing, the oxide material still has electric conduction properties and remains transparent. Thus, surprisingly, the optical properties of the material can be changed in the desired way by introducing metals without losing the other desirable properties of the material, i.e., to be conductive and transparent. Incidentally, “electric conduction properties” also includes electric semiconductor and antistatic properties of a material. Now, the metal which changes the spectral properties alters the original oxide material to have a different transmission, reflection and/or absorption behavior as compared to the original oxide material. Thus, oxide materials can be obtained which have a wide variety of spectral properties and thus can be employed for different uses, for example, by applying them to support materials, such as glass panes, or to or into materials such as polymers. Thus, by introducing a single material, both a changed infrared (IR) and ultraviolet (UV) transmission and a coloring effect can be achieved; in addition, for one and the same oxide material, the coloring effect can be determined only by the kind of metal chosen and/or its concentration. In particular, since the metal changes the chemical properties of the oxide material to a minimum extent at most, and typically not to any appreciable extent, it is easier, for example, to provide polymers with desired material properties, because the interactions between several different materials need no longer be considered.

In particular, at least two different metals may be provided in said transparent conductive oxide material. Thus, the oxide material in its known form may already have some metal content. In its original form, such oxide material may have electric conduction properties and thus be suitable for enabling at least an antistatic performance for surface coatings etc. Now, the second metal, which is additionally introduced or applied, can be selected for the oxide material to have a particular color and/or other optical properties. Thus, by selecting the two metals, it is possible to adapt the oxide material to a desired function in a substantially better way than would be possible by selecting one metal. Preferably, at least 50% of the oxide material will have a crystallite size and/or particle size of smaller than 500 nm.

In particular, in said transparent conductive oxide material, at least two different kinds of metal can be present in a concentration of, in sum or preferably each, at least 0.5 atomic percent, based on the oxide.

The metals are suitable and designed to influence the properties of the oxide material in a given way. Thus, the oxide can have a conductive or spectrum-changing effect due to the metal.

In particular, said transparent conductive oxide material can be in a nanoparticular form. Thus, the oxide material may have a particle size of not substantially larger than 1 μm on average. Even with such low particle sizes, positive effects are obtained in the invention.

Like conventional oxide materials, the particles according to the invention can be redispersed in a wide variety of media, and therefore it is possible to introduce them in a wide variety of polymers and/or coatings and/or paints, so that a plurality of properties of such materials are changed simultaneously. Thus, for example, plastic materials can be given both a colored and an IR-shielding and UV-resistant design by introducing a nanoparticular oxide material.

In particular, in a more preferred variant, ITO (In₂O₃:Sn) can serve as a starting oxide material. ITO is known as an IR-absorbing material which is also used as a coating material in vapor depositing. Also, ITO is already being admixed to plastic materials for IR shielding; thus, the properties of ITO as a coating and additive are known. Now, this base substance whose behavior and properties are known can be changed to have the desired spectral properties merely by additionally adding a metal.

In particular, said transparent conductive oxide material has a crystallite size of smaller than 1 μm. Thus, said oxide material will preferably be in a nanodisperse form. In such form, it can be introduced in a surface coating or polymer particularly uniformly according to the present invention.

In particular, said oxide material includes at least one metal which is a metal ion. The introduced metals or metal ions may be both main group and auxiliary group elements. Fe³⁺, Fe²⁺, Co, Ni, Mn, Mo, Cr, Ti, Zr, Ag, Cu, Au, Al, Ga, Ge, W, Zn, Eu, Tb, Yb, Ce, V, Cd, Bi, Sb and combinations thereof may be pointed out in particular.

In particular, said transparent conductive oxide material contains at least one coloring metal. Thus, the oxide material can be used for also achieving a coloring effect in a paint or polymer in addition to UV and/or IR shielding. In particular, said metal or said oxide material can be selected in such a way that said oxide material remains conductive or at least antistatic after the coloring metal has been introduced. Thus, by adding only one substance, both antistatic and colored plastic materials, paints, coatings etc. can be formed.

In addition, said transparent conductive oxide material may include a metal which is suitable for causing a higher UV absorption. Thus, in contrast to the original transparent conductive oxide material, the introduction of another metal may cause a higher UV absorption. Thus, the oxide material according to the invention is suitable for being used as a UV blocker, for example, for increasing the UV resistance of plastic materials. Thus, the preparation of an inorganic UV blocker is provided which thus has an extremely high resistance to bleaching etc.

In particular, said oxide material may include a metal which is suitable for causing a particularly high infrared absorption and/or for shifting the absorption to desired regions. The oxide material is still conductive, although a metal was added which just causes enhanced infrared absorptions. Thus, a transparent, conductive and particularly well IR-absorbing oxide material is available. This is advantageous in the preparation of transparent panes as demanded in the automobile branch or architecture.

Also provided are additives for plastic materials and/or coatings which include an oxide material according to the present invention. Such additives may be admixed to plastic materials or coatings and thus confer one or more of the previously described properties to the plastic material or coating. According to the invention, such plastic materials and/or coatings can be used for preparing panes therefrom or for coating panes therewith and thus provide them with the improved optical properties.

In particular, the particles according to the invention can be dispersible in various solvents usual for use with paints. Such solvents usual for use with paints may be the following, for example:

Water, alcohols (e.g., ethanol, propanol, isopropanol, butanol), ketones (e.g., acetone, MEK), diketones, diols, carbitols, glycols, diglycols, triglycols, glycol ethers (e.g., methoxy-, ethoxy-, propoxy-, isopropoxy-, butoxyethanol), esters, glycol esters (e.g., ethyl acetate, butyl acetate, butoxyethyl acetate, butoxyethoxyethyl acetate), alkanes and alkane mixtures, aromatics (e.g., toluene, xylene), DMF, THF, NMP and mixtures or derivatives thereof.

These can be admixed with binder systems, such as polyacrylates (e.g., PMMA), polyvinylpyrrolidone (PVP), polyvinylbutyral (PVB), polyvinylalcohols (PVA), polyethylene glycols, polycarbonate (PC), polystyrenes, polyurethanes, bisphenol-based polymers, polysulfones, polyolefins, polyesters, mixtures thereof and oligomers and monomers of the above mentioned polymers, cellulose derivatives (e.g., methylcellulose, hydroxypropylcellulose, nitrocellulose) to obtain a paint system for transparent coats. In addition to purely organic binder systems, others may also be employed, especially silicones, silanes and further organometallic compounds in monomeric, oligomeric as well as polymeric form.

These paint systems can be applied to substrates (e.g., glass, PC, PVC, PE, PP, PET, PMMA) by various wet methods (e.g., printing, spraying, spin-dip coating). After drying at clearly below 100° C., optically transparent structures are obtained. Also, it is possible to introduce these particles in UV-curable paint systems.

Further, plastic materials and/or coatings may include the oxide material according to the present invention. Such plastic materials or coatings thereby obtain an altered spectral behavior. In addition, the plastic materials and/or coatings can obtain conductive or antistatic properties due to said oxide material.

In the following, Examples of oxide materials according to the invention are presented. These Examples are by no means intended to limit the invention, but merely serve to illustrate it.

### COMPARATIVE EXAMPLE 1

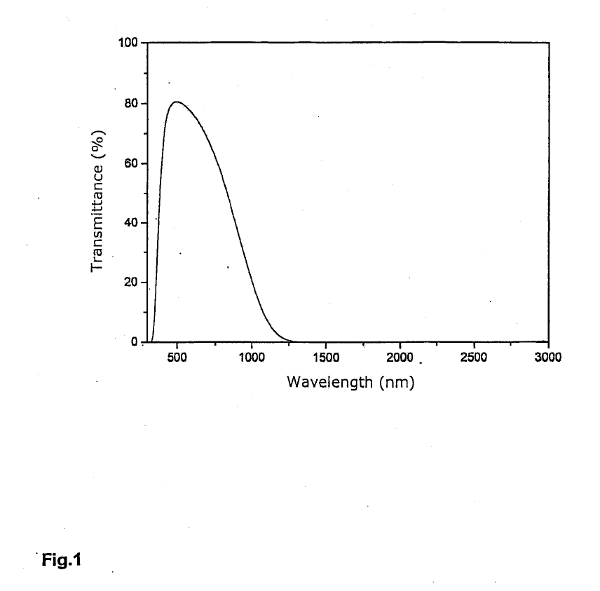

For comparison, a nanocrystalline ITO powder (In₂O₃/SnO₂) is prepared from an aqueous solution by a coprecipitation process in which soluble In and Sn components are precipitated by increases of the pH value. In this Example, the concentration of the compounds is chosen to be 7 atomic percent, based on In. In principle, the concentrations can be adjusted at will within broad limits. After the reaction product has been separated off, it is dried and annealed at 700° C. to adjust the crystalline phase. Fifty grams of an ethanolic dispersion of this nanocrystalline ITO with a solids content of 25% by weight was mixed with 50 g of a 15% by weight polymer solution of Paraloid B 72 in ethyl acetate. With this coating solution, glass, PC or PMMA sheets were coated by spin coating. Drying at 70° C. results in transparent colorless layers having a thickness of about 1 μm. The surface resistances of the layers were between 10⁴ and 10⁵ Ω/square. In FIG. 1, the spectral property or transmission of the thus prepared ITO layers is plotted against the wavelength.

### EXAMPLE 2

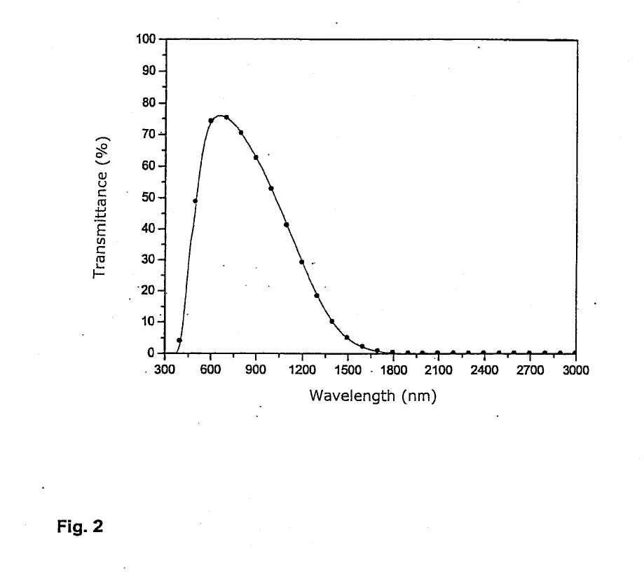

Further, an oxide material according to the invention was prepared by preparing a crystalline-doped In₂O₃/SnO₂ (ITO) powder as in Comparative Example 1, except that a soluble Fe²⁺ compound at a concentration of 5 atomic percent, based on In, was added in addition to the aqueous starting solution. Subsequently, it was arranged in layers as in Example 1. The layers are transparent, but have a golden yellow color in contrast to Example 1. The surface resistance was determined to be 10⁵ Ω/square. FIG. 2 shows the transmission curve and thus the spectral behavior of the thus prepared layers as a function of wavelength. FIG. 2 shows a spectral behavior of the substance prepared according to the invention which is changed with respect to Comparative Example 1. As can be seen, the transmission is clearly reduced with respect to Comparative Example 1 just in the spectral region of short wavelengths.

### EXAMPLE 3

A transparent conductive oxide material was prepared as in Comparative Example 1, except that 7 atomic percent of Fe²⁺ was added. As in Comparative Example 1, layers having a thickness of about 2 μm were prepared. As in Comparative Example 1, these layers were transparent, but had a brown color. Much like in the Comparative Example, the surface resistance was 10⁵ Ω/square.

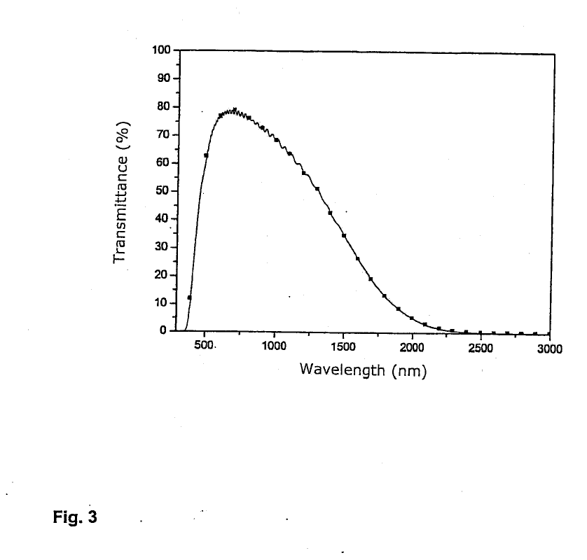

FIG. 3 shows the transmission curve for these layers.

### EXAMPLE 4

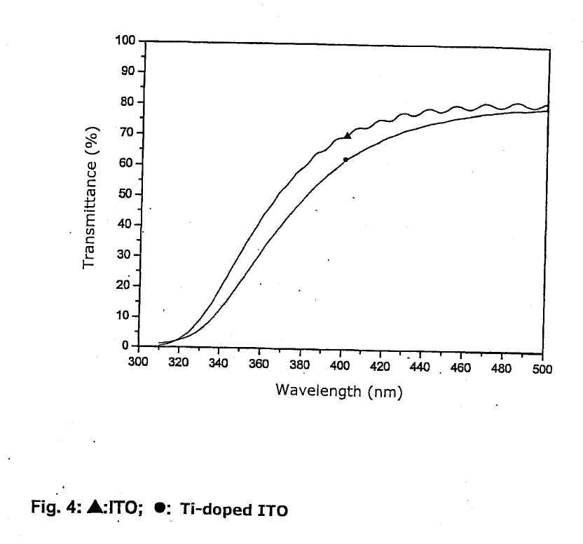

A conductive oxide material was prepared as in Example 2, except that 2 atomic percent of a titanium compound was added instead of Fe²⁺. Sixty grams of this powder as well as 60 g of ITO from Comparative Example 1 were dispersed in 100 g each of isopropoxyethanol (IPE), and the dispersion was admixed with 39 g of nitrocellulose. From the dispersions, layers on glass were prepared by means of a 50 μm doctor knife. After heating at 120° C. for one hour, the layer thicknesses were 4 μm. The material according to the invention formed a transparent bluish layer with a surface resistance of 10³-10⁴ Ω/square. FIG. 4 shows that the thus prepared layers have a lower transmittance for UV radiation than comparable ITO layers.

1. A transparent conductive oxide material, characterized in that said oxide material is provided with at least one metal suitable for altering the spectral properties.

2. The transparent conductive oxide material according to claim 1, characterized in that at least two different metals are provided.

3. The transparent conductive oxide material according to claim 2, characterized in that the at least two different metals are present in a total concentration of at least 0.5 atomic percent each, based on the oxide.

4. The transparent conductive oxide material according to claims 2 or 3, characterized in that said oxide material is a nanoparticular.

5. The transparent conductive oxide material according to claim 1, characterized in that said oxide material is ITO.

6. The transparent conductive oxide material according to claim 1, characterized in that said oxide material has an average crystallite size and/or particle size of smaller than 1 μm.

7. The transparent conductive oxide material according to claims 1 or 2, characterized in that said oxide material is provided with at least one coloring metal.

8. The transparent conductive oxide material according to claims 1 or 2, characterized in that said oxide material is provided with at least one metal suitable for causing a reduced UV transmittance.

9. A plastic material and/or coating including an oxide material according to claims 1 or 2.

10. A process for the preparation of an oxide material according to claims 1 or 2.

11. The transparent conductive oxide material according claim 1, characterized in that said oxide material has an average crystallite size and/or particle size of smaller than 500 nm.

12. The transparent conductive material according to claims 1 or 11 wherein at least 50% of said oxide material has a crystallite size or particle size of smaller than 500 nm.
